(19) United States
(12) Patent Application Publication
(10) Pub. No.: US 2009/0205736 A1
(43) Pub. Date: Aug. 20, 2009

(54) Flexible hose of thermoplastic material free of liquid plasticizer agents

(75) Inventors: Rinaldo Mezzalira, Arcignano di Sandrigo (IT); Alessandro Mezzalira, Sandrigo (IT)

Correspondence Address: Themis Law, 7660 Fay Ave Ste H535, La Jolla, CA, 92037, US

(73) Assignee: FITT SPA, Sandrigo (VI) (IT)

(21) Appl. No.: 12/305,016

(22) PCT Filed: Jun. 18, 2007
(86) PCT No.: PCT/IB07/52320

§ 371 Date: Dec. 16, 2008

(30) Foreign Application Priority Data
Jun. 16, 2006 (IT) VI2006A000185

(51) Int. Cl. F16L 11/04; B32B 1/08; F16L 11/08

(52) U.S. Cl. 138/137; 138/153; 138/125; 138/126

(57) ABSTRACT

A flexible hose, particularly for transporting food liquids, comprising at least one outer protective layer (2) of a first flexible polymer material (A) and at least one inner layer (3) of a second flexible polymer material (B). The second polymer material (B) comprises a thermoplastic compound (C1) of polyolefin nature and an elastomer compound (C2) in such a weight percentage as to impart a Shore A hardness of less than 85. Also, the second polymer material (B) is selected from polymer materials substantially free of liquid plasticizer agents.

### FIELD OF THE INVENTION

This invention finds application in the field of flexible hoses, and particularly relates to a flexible hose of thermoplastic material free of liquid plasticizer agents, particularly for transporting food liquids.

### BACKGROUND OF THE INVENTION

Flexible hoses for transporting food liquids are known to be made from a plastic material added with plasticizer agents, which are designed to improve processability and flexibility of the final product. When hoses are made from a thermoplastic elastomer material, liquid-state plasticizer agents are used, such as mineral oil or the like.

Plasticizer agents are further known to be subjected to the so called “migration” under thermal and/or mechanical stresses, i.e. release into the surrounding environment and/or the transported liquid, thereby involving pollution problems and/or alterations. Furthermore, as a result of migration, the hose stiffens, loses its original flexibility and can crack or even collapse.

The need has been long felt for a flexible hose of thermoplastic material free of liquid plasticizer agents having high flexibility, similar to a hose having liquid plasticizer agents.

### SUMMARY OF THE INVENTION

The object of the present invention is to overcome the above drawbacks, by providing a flexible hose that is highly efficient and relatively cost-effective.

A particular object is to provide a flexible hose of thermoplastic material free of liquid plasticizer agents having a good flexibility.

A further object is to provide a hose that does not alter and/or pollute the surrounding environment and/or the transported fluid.

Yet another object of the invention is to provide a flexible hose that is not subject to UV-induced alterations.

These and other objects, as better explained hereafter, are fulfilled by a flexible hose as defined in claim 1, comprising at least one outer protective layer of a first flexible polymer material and at least one inner layer of a second flexible polymer material. The second polymer material comprises a thermoplastic compound of polyolefin nature.

According to the invention, the second polymer material further comprises an elastomer compound in such a weight percentage as to impart a Shore A hardness of less than 85. Also, the second polymer material is selected from the group of polymer materials substantially free of liquid plasticizer agents.

Thanks to this particular configuration, the hose of the invention exhibits a good flexibility although it is substantially free of liquid plasticizer agents.

The nearly complete replacement of liquid plasticizer agents with a sufficient amount of elastomer compound to impart a Shore A hardness of less than 85 to the second polymer material, allows to fulfill the need that has long been felt in prior art for a flexible hose formed from an elastomer material free of liquid plasticizer agents.

The use of a polymer material substantially free of liquid plasticizer agents further avoids pollution and/or contamination of the surrounding environment and/or the transported liquid. Also, any problem associated to the loss of flexibility and/or to stiffening typically occurring in prior art hoses comprising liquid plasticizers will be substantially avoided.

Unless otherwise stated, the term “percentage by weight with respect to a material”, as used herein, is meant to designate the dry weight percentage of a compound of interest based on the total dry weight of material in which such compound is present.

The term “polymer materials substantially free of liquid plasticizer agents”, as used herein, is meant to designate polymer materials in which the weight percentage of the liquid plasticizer agent with respect to said polymer material is less than 0.1%.

The term “liquid plasticizer agents” as used herein is meant to designate a compound or a mixture of compounds that are in a liquid state at ambient temperature and pressure (T=20° C., P=1 atm).

Advantageously, the second polymer material may have a Shore A hardness of 60 SHA to 85, more preferably of about 70.

Conveniently, the elastomer compound may represent 55% to 85%, preferably about 75% by weight, based on the sum of the elastomer compound and the thermoplastic compound.

### BRIEF DESCRIPTION OF DRAWINGS

Further features and advantages of the invention will be more apparent upon reading the detailed description of a preferred, non-exclusive embodiment of a hose according to the invention, which is described as a non-limiting example with the help of the annexed drawings, in which:

FIG. 1 is a perspective view of one embodiment of the hose according to the invention;

FIG. 2 is a sectional view of the hose of FIG. 1, as taken along a plane II-II.

FIG. 3 is a view of a particular embodiment of the hose according to the invention with the outer layer omitted.

### DETAILED DESCRIPTION OF A PREFERRED EMBODIMENT

Referring to the above figures, the hose according to the invention, generally designated by numeral 1, may be advantageously used for transporting fluids, particularly food liquids.

In a preferred, non exclusive embodiment, the hose of the invention is advantageously used for transporting potable irrigation water in outdoor environments, such as a garden, a meadow, or the like.

The hose 1 essentially comprises an outer protective layer 2 of a first flexible polymer material A and an inner layer 3 which, in the example as shown in the annexed figures, may be in direct contact with the fluid to be transported, made from a second flexible polymer material B comprising a polyolefin-based thermoplastic compound, preferably selected from the group comprising polypropylenes, polyethylenes or the like.

According to the invention, the second polymer material B further comprises an elastomer compound C2 representing such a weight percentage as to impart a Shore A hardness of less than 85. Also, the second polymer material B will be selected from polymer materials substantially free of liquid plasticizer agents.

It shall be understood that, besides the thermoplastic compound C1 and the elastomer compound C2, the second polymer material B may include other compounds or mixtures of compounds without departure from the scope as defined in the annexed claims. By way of example and without limitation, the second polymer material B may include a filler compound D, such as, without limitation, calcium carbonate, kaolin or talc, individually or in combinations of two or more thereof, in a suitable weight percent. Conveniently, such weight percentage may be from 5% to 30% based on the total weight of the second polymer material B.

Advantageously, the elastomer compound C2 may be selected from the group comprising SEBS, SEPS, EPDM, polyolefin elastomers or the like.

Furthermore, in a preferred, non exclusive embodiment of the invention, the second polymer material B may be selected from the group comprising polyvinyl chloride (PVC)-free polymer materials, to avoid any dioxin-emission problem associated to incineration of such compound.

A few samples of second polymer materials B, comprising a mixture of an elastomer compound C2 and a thermoplastic compound C1 will be described hereinbelow for illustration purposes only. These samples were measured for Shore A hardness according to the well-known ISO 868 standard.

As a non-limiting example, the elastomer compound C2 is a SEBS and the thermoplastic compound C is a polypropylene (PP). Nevertheless, it shall be understood that any other elastomeric compound C2 and/or thermoplastic compound C1 may be used without departure from the scope of the invention, as defined by the annexed claims.

The weight percentages indicated in the table below are weight percentages based on the total weight of the sum of the elastomer compound and the thermoplastic compound (C2+C1). The weight percentage of the sum of the elastomer compound and the thermoplastic compound (C1+C2) based on the weight of the second polymer material B is identical in all samples. The weight percentage of the sum of the elastomer compound and the thermoplastic compound (C1+C2) based on the weight of the second polymer material B is identical in all samples.

| | C1 compound % | C2 compound % | Sh A hardness |
|---|---|---|---|
| Samp 1 | 50 | 50 | 96 |
| Samp 2 | 40 | 60 | 83 |
| Samp 3 | 30 | 70 | 74 |
| Samp 4 | 25 | 75 | 70 |
| Samp 5 | 20 | 80 | 64 |
| Samp 6 | 10 | 90 | 57 |

“Samp 1” designates a first sample of a second polymer material B comprising 50% of the elastomer compound C2 and 50% of the thermoplastic compound C1. The results show that this first sample has an unacceptably high Shore A hardness (96) for the purposes hereof.

“Samp 2” designates a second sample of a second polymer material B comprising 40% of the elastomer compound C2 and 60% of the thermoplastic compound C1. The results show that this second sample has an acceptable Shore A hardness (83) for the purposes hereof.

Without being bound to any theory, it can be established that a polymer material free of liquid plasticizer agents having a Shore A hardness of more than 85 does not fall within the scope of this invention.

Without being bound to any theory, it can be established that a polymer material free of liquid plasticizer agents in which the elastomer compound C2 has a weight percentage of less than 55% with respect to the sum of the thermoplastic compound and the elastomer compound (C1+C2), does not fall within the scope of this invention.

“Samp 3” designates a third sample of a second polymer material B comprising 30% of the elastomer compound C2 and 70% of the thermoplastic compound C1. The results show that this third sample has a good Shore A hardness (74) for the purposes hereof.

“Samp 4” designates a fourth sample of a second polymer material B comprising 25% of the elastomer compound C2 and 75% of the thermoplastic compound C1. The results show that this fourth sample has a very good Shore A hardness (70) for the purposes hereof.

“Samp 5” designates a fifth sample of a second polymer material B comprising 20% of the elastomer compound C2 and 80% of the thermoplastic compound C1. The results show that this fifth sample has an acceptable Shore A hardness (64) for the purposes hereof.

“Samp 6” designates a sixth sample of a second polymer material B comprising 10% of the elastomer compound C2 and 90% of the thermoplastic compound C1. The results show that this sixth sample has an unacceptably low Shore A hardness (57) for the purposes hereof.

Without being bound to any theory, it can be established that a polymer material free of liquid plasticizer agents having a Shore A hardness of less than 60 does not fall within the scope of this invention.

Without being bound to any theory, it can be established that a polymer material free of liquid plasticizer agents in which the elastomer compound C2 has a weight percentage of more than 85% with respect to the sum of the thermoplastic compound and the elastomer compound (C1+C2), does not fall within the scope of this invention.

Advantageously, the first polymer material A of the outer protective layer 2 may include a UV filter E, preferably selected from the group comprising titanium oxide, silica, carbon black, zinc oxide or the like.

Preferably, the filter E will be present in a weight percentage of 0.1% to 10% based on the total weight of the first polymer material A.

It shall be understood that both the first polymer material A and the second polymer material B may have whichever compositions, possibly similar compositions, and particularly the first polymer material A may include a thermoplastic compound C1 and/or an elastomer compound C2 and the second polymer material B may include a filter E, in any weight percentages, possibly similar, without departure from the scope of the invention as defined by the annexed claims.

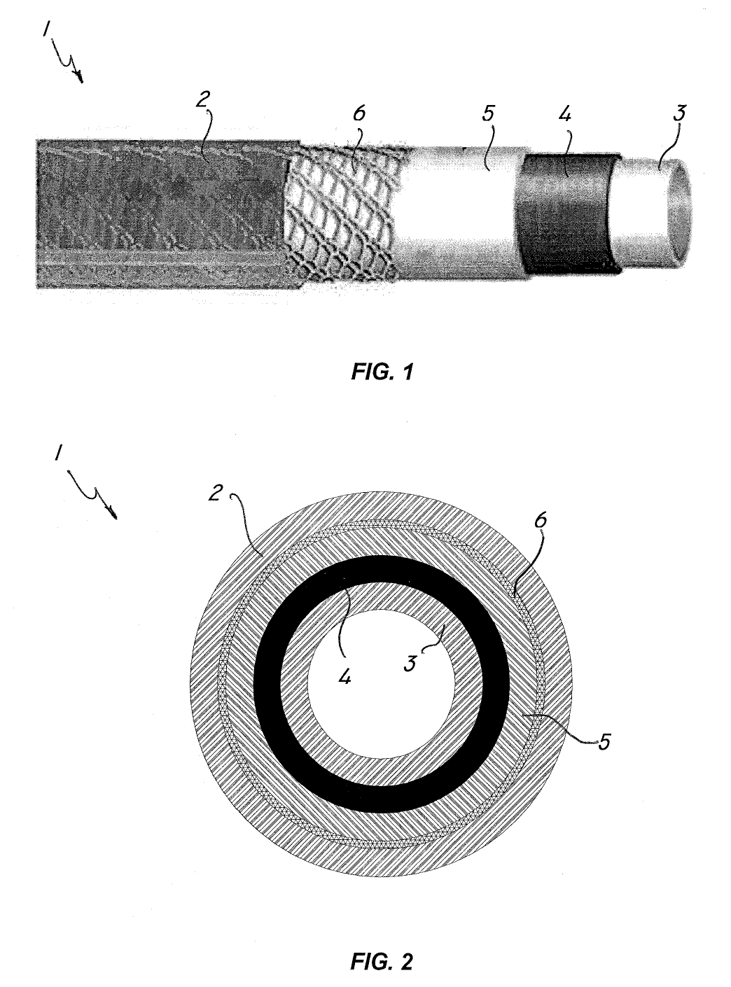

Furthermore, in a preferred non exclusive embodiment of the invention, the hose 1 may have additional intermediate layers, designated in FIGS. 1 and 2 by numerals 4, 5 and 6. Nevertheless, it shall be understood that any other layer may be interposed between the outer layer 2 and the inner layer 3 without departure from the scope of the invention, as defined by the annexed claims.

The intermediate layer 4 may be formed from a third polymer material F, which may be identical to the second polymer material B and include a dark coloring agent G, preferably of the carbon black type, for preventing algal bloom within the hose, in a weight percentage of 0.1% to 10% based on the weight of the third polymer material F.

The layer 5 may be similar to the inner layer 3, and be thus formed from a fourth polymer material H similar to the second polymer material B.

The fibrous reinforcement layer 6 may have a spiral wrapped or mesh form with simple or double chain stitches, and be formed in accordance with the teachings of patents EP-B1-0623776 or EP-B1-0960297, by the Applicant hereof.

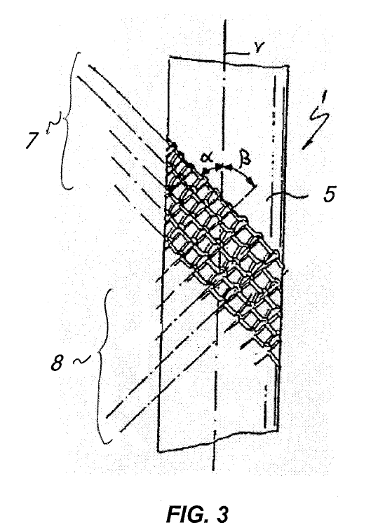

Particularly, as shown in FIG. 3, the chain-mesh fibrous layer 6 may have substantially parallel rows of stitches 7 and substantially parallel lines of stitches 8. Advantageously, the lines 8 and the rows 7 of stitches may be mutually inclined with respect to the longitudinal axis Y of the hose, at respective predetermined angles α, β.

In operation, the hose may be formed using well-known techniques, such as coextrusion.

In the light of the foregoing, it clearly appears that the hose of the invention fulfills the intended objects and particularly meets the requirement of providing a flexible hose of thermoplastic material free of liquid plasticizer agents, which has a good flexibility.

Thanks to the nearly complete replacement of liquid plasticizer agents with a sufficient amount of elastomer compound C2 to impart a Shore A hardness of less than 85 to the second polymer material, the long-felt prior art need for a flexible hose formed from an elastomer material free of liquid plasticizer agents can be fulfilled.

The hose according to the invention is susceptible of a number of changes and variants, within the inventive concept disclosed in the appended claims. All the details thereof may be replaced by other technically equivalent parts, and the materials may vary depending on different needs, without departure from the scope of the invention.

While the hose has been described with particular reference to the accompanying figures, the numerals referred to in the disclosure and claims are only used for the sake of a better intelligibility of the invention and shall not be intended to limit the claimed scope in any manner.

1. A flexible hose, comprising at least one outer protective layer (2) of a first flexible polymer material (A) and at least one inner layer (3) of a second flexible polymer material (B), said second polymer material (B) in direct contact with the fluid to be transported, said second polymer material (B) comprising a polyolefin thermoplastic compound (C1) and an elastomer compound (C2) in such a weight percentage as to impart a Shore A hardness of less than 85 to said second polymer material (B),
characterized in that said second polymer material (B) is selected from the group of polymer materials substantially free of liquid plasticizer agents in order to avoid pollution and/or contamination of the transported liquid and/or the surrounding environment and to render the hose suitable for transporting food liquids.

2. Hose as claimed in claim 1, characterized in that said second polymer material (B) has a Shore A hardness of 60 to 85, and preferably close to 70.

3. Hose as claimed in claim 1, characterized in that said elastomer compound (C2) is present in said second polymer material (B) in a weight percentage of 55% to 85%, preferably close to 75%.

4. Hose as claimed in claim 1, characterized in that said elastomer compound (C2) is selected from the group comprising SEBS, SEPS, EPDM, polyolefin elastomers or the like.

5. Hose assembly as claimed in claim 1, characterized in that said second polymer material (B) is selected from the group comprising polyvinyl chloride-free polymer materials.

6. Hose as claimed in claim 1, characterized in that said thermoplastic compound (C1) is present in a weight percentage of 45% to 15%, and preferably close to 25%.

7. Hose as claimed in claim 1, characterized in that polyolefin thermoplastic compound (C1) is selected from the group comprising polypropylenes, polyethylenes or the like.

8. Hose as claimed in claim 1, characterized in that said first polymer material (A) of said outer protective layer (2) comprises a UV filter (E).

9. Hose as claimed in claim 8, characterized in that said filter (E) is selected from the group comprising titanium oxide, silica, carbon black, zinc oxide, or the like.

10. Hose as claimed in claim 8, characterized in that said filter (E) may be present in a weight percentage of 0.1 to 10% relative to the total weight of said first polymer material (A).

11. Hose as claimed in claim 1, characterized in that it further has an intermediate layer (4) of a third flexible polymer material (F) interposed between said outer protective layer (2) and said inner layer (3).

12. Hose as claimed in claim 11, characterized in that said third polymer material (F) comprises a dark coloring agent (G) for preventing algal bloom within the hose.

13. Hose as claimed in claim 12, characterized in that said coloring agent (G) is of the carbon black type.

14. Hose as claimed in claim 13, characterized in that the carbon black coloring agent content is from 0.1% to 10% by weight.

15. Hose as claimed in claim 1, characterized in that it has a fibrous reinforcement layer (6) interposed between said outer layer (2) and said inner layer (3).

16. Hose as claimed in claim 15, characterized in that said fibrous reinforcement layer (6) has a spiral wrapped or mesh form with simple or double chain stitches.

17. Hose as claimed in claim 16, characterized in that said chain-mesh fibrous layer (6) has substantially parallel rows of stitches (7) and/or substantially parallel lines of stitches (8).

18. Hose as claimed in claim 17, characterized in that said lines of stitches (8) and said rows of stitches (7) are mutually inclined with respect to the longitudinal axis (Y) of the hose, at respective predetermined angles (α, β).
